(19) United States
(12) Patent Application Publication
(10) Pub. No.: US 2010/0115567 A1
(43) Pub. Date: May 6, 2010

(54) SYSTEM AND METHOD FOR PAUSING PROGRAMMING OF A TELEVISION FOR A TELEPHONE CALL

(76) Inventors: Shekhar Gupta, Overland Park, KS (US); Curtis Tucker, Lees Summit, MO (US); Robert Morrill, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/261,687

(22) Filed: Oct. 30, 2008

(51) Int. Cl. H04N 7/173

(52) U.S. Cl. 725/106

(57) ABSTRACT

A method of controlling a television includes receiving an indication of a telephone call at a set-top box and pausing the display of television content by the set-top box in response to the received indication.

### BACKGROUND

The demand for coordinated management and control of television and telephone services has increased among consumers. Such demand has created a market for new features and functionality associated with traditional services enjoyed by a consumer, particularly those features and functionality that emphasize convenience of use.

### SUMMARY

In one embodiment of the present invention, a method of controlling a television includes receiving an indication of a telephone call at a set-top box and pausing the display of television content by the set-top box in response to the received indication.

In another embodiment of the present invention, a set-top box includes a telephone interface operable to receive an indication of a telephone call and a digital video recorder operable to pause the display of television content by the set-top box in response to the received indication.

In a further embodiment of the present invention, a system for controlling a television includes a processor and a memory in communication with the processor. The memory is encoded with instructions that are operable when executed by the processor to receive an indication of a telephone call at a set-top box and pause the display of television content by the set-top box in response to the received indication.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of one embodiment of a communications system that may include various elements used for wireless and wired communications;

FIG. 2 illustrates one embodiment of a method for controlling a television;

FIG. 3 illustrates one embodiment of a system for controlling a television; and

FIG. 4 illustrates one embodiment of a system for ring monitoring;

FIG. 5 illustrates one embodiment of a user interface for implementing particular features of the present invention; and

FIG. 6 illustrates one embodiment of a method of selecting preferences for controlling television content.

### DETAILED DESCRIPTION OF THE DRAWINGS

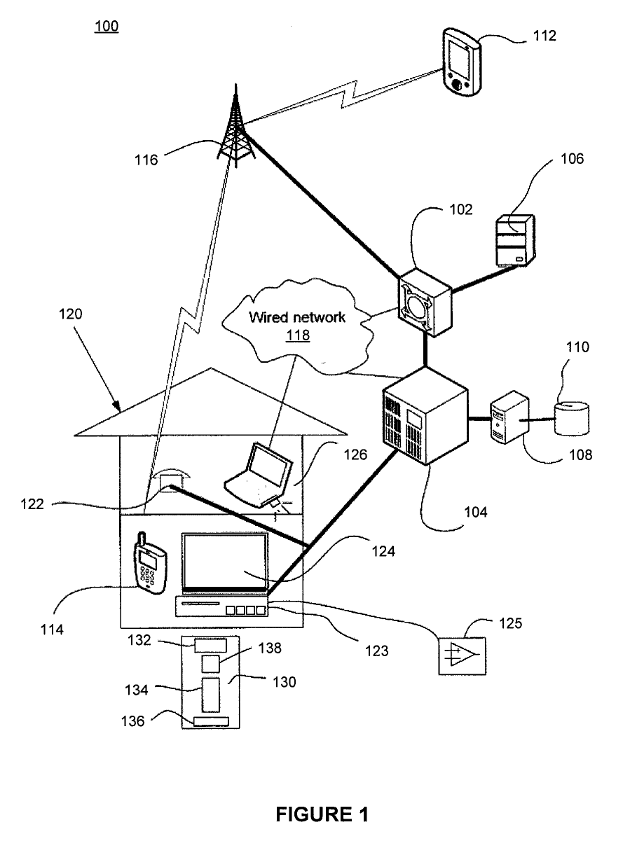

FIG. 1 is a pictorial representation of a communications system 100 in accordance with an illustrative embodiment. In operation, communication system 100 may be used to configure and operate a set-top box or other source of controlling media content such that the broadcast, streaming, or playback of content is paused or recorded when a telephone call is initiated or received. The integrated nature of communication system 100 allows such functionality to be easily implemented and configured to the preferences of a user.

The communication system 100 of FIG. 1 includes various elements used for wireless and wired communication. The communications system 100 includes a mobile switching center (MSC) 102, a local exchange 104, multi-media messaging systems 106 and 108, a database 110, wireless devices 112 and 114, a transmission tower 116, a wired network 118, a home 120, home telephone 122, a set-top box 123, a display 124, and a client 126. The different elements and components of the communications system 100 may communicate using wireless communications, such as satellite connections, WiFi, WiMAX, CDMA wireless networks, and/or hardwired connections, such as fiber optics, T1, cable, DSL, high speed trunks, and telephone lines.

The wireless devices 112 and 114 may communicate with the transmission tower 116 using communications protocols, such as time division multiple access (TDMA), code division multiple access (CDMA), global systems for mobile (GSM) communications, personal communications systems (PCS), WiFi, WLAN, WiMAX, or other frequently used cellular and data communications protocols and standards. The wireless devices 112 and 114 may include cellular phones, Blackberry® devices, personal digital assistances (PDA), mp3 players, laptops, evolution data optimized (EDO) cards, multi-mode devices, and other wireless communication devices and elements.

Communications within the communications system 100 may occur on any number of networks which may include wireless networks, data or packet networks, cable networks, satellite networks, private networks, publicly switched telephone networks (PSTN), the wired network 118, or other types of communication networks. A communications network is the infrastructure for sending and receiving signals and messages according to one or more designated formats, standards, and protocols. The networks of the communications system 100 may represent a single communication service provider or multiple communications services providers. The features, services, and processes of the illustrative embodiments may be implemented by one or more elements of the communications system 100 independently or as a networked implementation.

In one embodiment, the MSC 102, multi-media messaging systems 106 and 108, and transmission tower 116 are part of a wireless network that is operated by a wireless service provider. For example, the control signals and operational features may be performed by the MSC 102 and the wireless signals may be broadcast from the transmission tower 116 to the wireless devices 112 and 114. The wireless network may include any number of systems, towers, servers, and other network and communications devices for implementing the features and performing the methods herein described. The wireless network may enable cellular, data, radio, television service, or other wireless schemes. For example, the transmission tower 116 may transmit signals to cell phones, Blackberry® devices, car radios, and high definition televisions.

The MSC 102 may be a switch used for wireless call control and processing. The MSC 102 may also serve as a point of access to the local exchange 104. The MSC 102 is a telephone exchange that provides circuit switched calling and mobility management and may also provide GSM or PCS services to the wireless devices 112 and 114 located within the area the MSC 102 serves. The MSC 102 may include or communicate with a home location register (HLR) and visitor location register (VLR) that may be used to implement different features of the illustrative embodiments. The multi-media messaging system 106 may be an integrated part of the MSC 102 or alternatively may be an externally connected device.

In one embodiment, the multi-media messaging system 106 may include an integrated database for storing customer and usage information, electronic profiles, and data. In one embodiment, multi-media messaging system 106 is a media player such as a voicemail platform. In another embodiment, the multi-media messaging system 106, a server, or other intelligent network device may store user preferences, applications, features, messages, and implementation logic, as further described herein. The user may communicate, interact, or send and receive data, information, and commands to the multi-media messaging system 106 through the telephone 122, set-top box 123, display 124, wireless device 112 and 114, or the client 126. The MSC 102 and multi-media messaging system 106 may include any number of hardware and software components. In one embodiment, the MSC 102 is an advanced intelligence network device with software modules equipped to perform a do-not-disturb feature.

The local exchange 104, the MSC 102, and/or other elements of the communications system 100 may communicate using a signal control protocol, such as a signaling system number 7 (SS7) protocol or TCP/IP protocols. The SS7 protocol or similar protocols are used in publicly switched networks for establishing connections between switches, performing out-of-band signaling in support of the call-establishment, billing, routing, and implementing information-exchange functions of a publicly switched network or the wired network 118. The local exchange 104 may be owned and operated by a local exchange carrier that provides plain old telephone service (POTS) to any number of users. In one embodiment, the local exchange 104 may be a class 5 switch that is part of the network systems of the local carrier. The local exchange 104 may include or may be connected to the multi-media messaging system 106. However, the local exchange 104 may also be a Digital Subscriber Line Access Multiplexer (DSLAM), Internet Protocol (IP) gateway, base station, or any other suitable network access point.

The local exchange 104 may be a wire-line switch or public exchange using time domain multiplexing to provide telecommunications services to a particular subscriber or group of subscribers. The local exchange 104 may be located at a local telephone company's central office, or at a business location serving as a private branch exchange. The local exchange 104 may provide dial-tone, calling features, and additional digital and data services to subscribers, such as the home telephone 122. The local exchange 104 may also enable Voice over Internet Protocol (“VoIP”) communication of the home telephone 122 through a data network. VoIP works by sending voice information in digital form, such as packets, rather than using the traditional circuit-committed protocols of the publicly switched network. The local exchange 104 may be or include a feature server, a call control agent, an IP gateway, and other devices or applications for implementing VoIP communications. In one embodiment, the local exchange 104 may be more than one distributed devices, such as an IP gateway in communication with a call control server, such as a Session-Initiation Protocol (SIP) server for setting up Voice-over Internet Protocol (VoIP) calls.

The communications system 100 may further include any number of hardware and software elements that may not be shown in the example of FIG. 1. For example, in order to facilitate VoIP communications, the communications system 100, and the MSC 102 and local exchange 104, in particular, may include additional application servers, media servers, service brokers, call agents, edge routers, gateways (signaling, trunking, access, sub, etc.), IP network service providers, adapters, exchanges, switches, users, and networks. The multi-media messaging system 108 is similar to the multi-media messaging system 106 except that it is equipped to handle multi-media messaging for landline customers rather than wireless customers.

The MSC 102 and the local exchange 104 may include an authentication space. The authentication space may be a partition, module, or other storage or memory of the server designated by the communications service provider. The authentication space may validate that a user or device, such as client 126, is allowed to authorize the MSC 102, local exchange 104, servers, switches, network devices, or corresponding multi-media messaging systems 106 and 108 to set preferences, implement changes, review information, or perform other updates. For example, a user may first be required to provide a secure identifier, such as a user name, password, or other authentication code or hardware interface, to verify the user is authorized to make changes to a feature within the authentication space.

The authentication information may also be used to create a secure connection between the client 126 and the MSC 102, a server, or the local exchange 104. The secure connection may be a virtual private network tunnel, an encrypted connection, firewall, or other form of secured communications link. The MSC 102 and local exchange 104 may use any number of gateways, proxies, applications, or interfaces for allowing the client 126 to communicate with the MSC 102 and local exchange 104 through the wired network 118. Alternatively, the client 126 may use a wireless network or other network to access the MSC 102 and local exchange 104. The MSC 102 and local exchange 104 may use a host client application for communicating with numerous clients.

The home 120 is an example of a dwelling, residence, or location of a person or group that may utilize any number of communications services. The home 120 is shown as a residence in the illustrated example, however, the home 120 may also be an office, business, or other structure wired or otherwise suitably equipped to provide telephone, data, and other communication services to one or more customers. In one embodiment, the home 120 is equipped with multiple communication devices, including home telephone 122 and client 126. The home telephone 122 may be standard devices that provide dialing and voice conversation capabilities. Home telephone 122 may be integrated in any number of other devices or may be used in different forms. For example, the home telephone 122 may be part of a refrigerator or intercom system. In another embodiment, the home telephone 122 may be integrated with a personal computer, such as client 126.

The communications services accessible from the home telephone 122 may include POTS or VoIP telephone service. The home telephone 122 may be VoIP telephones or may be standard telephones that include a modem and/or VoIP adapters for enabling VoIP communications. A special dial tone, message, web alert, or other feedback may specify once or repeatedly that the home telephone 122 is implementing a particular feature.

The client 126 may be a personal computer for performing and executing programs and instructing and accessing the wired network 118. However, the client 126 may be any computing device suitable for communicating with the wired network 118 through a network connection. The wired network 118 may be a fiber optic, cable, or telephone network or other wired network suitable for communication over a hard wired connection with the client 126. In one embodiment, the home 120 may include a wireless router, adapter, switch, hub, or other suitable interface that allows the client 126 to communicate with the wired network 118. Alternatively, the client 126 may communicate with the wired network 118 through a wireless connection. The set-top box 123 and the display 124 may also communicate through the wired network 118.

Client 126 may be utilized for setting preferences for pausing the programming of a set-top box in response to a detected telephone call. For purposes of this application, telephone call includes any multi-media telephony communication. For example, such preferences may indicate which telephones associated with a household or user trigger a pausing or recording of programing when a call is conducted on such telephone. Similarly, a preference may indicate that programming resumes after three unanswered rings, after a call is completed, after a call goes to multi-media messaging, after a resume or similar button is pressed on a telephone, remote control, or set-top box, after any button is pressed on a remote control, or when an accelerometer or other indicator detects that a remote has been picked up by a user. Additionally, a preference may indicate that programming should only be paused or recorded if a particular type of programming is being played. In one embodiment, only movies may be paused. In another embodiment, only particular televisions are paused as indicated by a user. In yet another embodiment, the pausing of programming or other content only occurs each time a user picks up a phone, each time a dial tone is detected, each time a key is pressed or a send button is pressed, only for inbound calls, or only for inbound calls received from particular individuals or telephone numbers. In another embodiment, the pausing of programming only occurs for outbound calls. Such preferences may then be communicated over a network to set-top box 123, either directly, or through an interface with a service provider such as a cable company.

In one embodiment, client 126 may be used to access a network address book of a user that is stored locally by the user or remotely by a service provider. In one embodiment, preferences may be established to only pause the playing of media content when a call is received from someone that is identified as being in the user's network address book. In another embodiment, preferences maybe established to only pause the playing of media content when a call is received from someone that is identified as being in a particular portion of the user's network address book, such as a work or personal contacts portion. In yet another embodiment, preferences maybe established to only pause the playing of media content when a call is received from someone that is flagged as being a particular type of contact in a network address book, such as a family member contact or a long distance contact. In one embodiment, different network address books may be available for different members of a household. In such embodiment, calls from contacts identified as being in a particular member's network address book may trigger a pausing or recording of media while calls from contacts identified as being in another member's address book will not invoke such a trigger.

The set-top box 123 is a device that configures media content for display by the display 124. In one embodiment, the set-top box 123 may function as a receiver, a digital video recorder, and a personal video recorder for displaying any number of audio, video, or static media content through speakers, the display 124 or other interconnected devices. Set-top box 123 may include functionality to translate a detected telephone call into a command to pause or record programming or other played media content. For example, the set-top box 123 may process media signals from a satellite provider, cable provider, DSL connection, Internet Protocol television (IPTV) connection, or other connection types and/or providers. Such media signals may be interrupted, paused, muted, or recorded in response to a detected telephone call. In one embodiment, the set-top box 123 also includes a modem for dialing and connecting telephone calls. In yet another embodiment, the set-top box 123 also includes a digital telephony client communicating using any suitable voice protocol such as VoIP. The digital telephony client may include a SIP stack for conducting a VoIP voice call. Alternatively, a peer-to-peer digital telephony client such as a Skype® client or any other suitable digital telephony client may be utilized.

In one embodiment, the set-top box 123 may communicate with the local exchange 104 to set-up a VoIP call using, for example, a SIP protocol. In such an embodiment, the set-top box 123 would communicate through an IP gateway to a call control server in order to set up an incoming voice call path and an outgoing voice call path between the set-top box and a device associated with a selected telephone number or IP address. In an alternative embodiment, the set-top box 123 may communicate through an IP gateway to a call control server (such as a call control manager) in order to set up an incoming voice call path and an outgoing voice call path between a device associated with a selected telephone number or IP address and a second device designated by the set-top box 123 or selected by a user of the set-top box 123. For purposes of this application, calling party number and originating number shall be used to refer to a telephone number or IP address of a party initiating a telephone call and a called party number and destination number shall be used to refer to a number of a party designated as the recipient of a telephone call.

In one embodiment, the user of the set-top box 123 may be prompted to take the call in response to a call control server, MSC, or local exchange causing a telephone of the user to ring where such telephone is not connected to the same network as the set-top box 123. In such an embodiment, the IP address or telephone number for such telephone of the user may be stored by the set-top box 123 or selected or input by the user. In such an embodiment, the set-top box 123 would instruct the call control server, MSC, or local exchange to utilize such IP address or telephone number instead of the IP address or telephone number of the set-top box 123 as the originating number when setting up a call. The call control server, MSC, or local exchange could be easily modified to generate a ring to the originating number upon connection of the call to a destination number, while, for example, playing a prerecorded message, tone, or other audio output to the person answering the call at the destination number. In one embodiment, the set-top box 123 may select one of several IP addresses or telephone numbers to use as an originating number in response to a user selection or automatically by detecting the identity of the user, the location of the user, or any other suitable criteria. For example, the set-top box 123 may show that a particular user is using the set-top box 123, either because of login information or in response to known viewing patterns of the user. In such example, the cell phone number of that particular user will be used as the originating number. In one embodiment, a plurality of set-top boxes 110 may be networked and share the call set-up platform to initiate telephone calls. In such an embodiment, an originating number corresponding to a telephone number or IP address of a device located in the same room as the set-top box being accessed by the user to, for example, watch television. The pausing of programming may be configured with preferences to only occur if a particular user is watching television.

The set-top box 123 may also include a noise cancellation generator 125. In one embodiment, the noise cancellation generator 125 is an application specific integrated circuit operable to receive an audio signal, generate an inverse of such audio signal, and output such inverse for combination with the original audio signal over, for example, the outbound voice path of a telephone call. In one embodiment, noise cancellation generator 125 may include hardware and software components, and may receive as an input an audio signal either from the audio out path of a speaker of a television or surround sound system, from a microphone input receiving an audio signal from a speaker of a television or surround sound system, or directly from a cable television feed or other audio channel received over a network, from a prerecorded medium, or other audio source. In one embodiment, in response to a telephone call being connected between a user of a set-top box and a called party, the set-top box may communicate information to a set-top box of the called party over the network utilized to provide television services. For example, a television signal being viewed by a user of the set-top box may be communicated to the called parties' set-top box such that both parties may view the same television content. Information regarding calls made by a user of a set-top box may also be communicated over the network used to provide services to a set-top box. For example, call information may be logged and tracked for purposes of record keeping and/or billing by a provider of network services.

In one embodiment, the set-top box 123 includes a network-to-network interface capable of translating digital packet telephony calls to analog telephony calls and vice versa. More particularly, the set-top box 123 may include the functionality to disassemble IP packets that may include call signaling and voice data into the separate signaling and data components necessary to communicate with an analog telephony network.

The display 124 is a device for visually displaying and presenting media content. In one embodiment, display 124 is a television. The display 124 may also be a laptop, desktop, projector, monitor, or other device suitable for playing an audio-visual selection.

Communications system 100 also includes a remote control 130. In one embodiment, the remote control 130 is the user input device 200. The remote control 130 includes a transmitter 132 for communication with the set-top box 123. In one embodiment, such transmitter is an infrared transmitter. However, alternatively, such transmitter may be a light emitting diode, a wireless transmitter, or any other suitable component suitable to communicate information to the set-top box 123. In yet another embodiment, the transmitter is a wireless transceiver in communication with the set-top box, for example, in the manner of wireless devices 112 and 114. For purposes of this application, a remote control equipped with a wireless transceiver shall also be referred to as a wireless set. The remote control also includes a user interface 134. In one embodiment, the user interface 134 includes buttons for indicating the selections of a user. Alternatively, the user interface may include buttons, dials, wheels, graphical user interfaces, touch screens, or accelerometers suitable for indicating the selections of a user. In one embodiment, the user interface 134 also includes a microphone 136 and a speaker 138. In yet another embodiment, the remote control 130 is a dumb wireless set. For purposes of this application, a “dumb wireless set” shall mean a wireless device with no user interface other than a microphone and speaker.

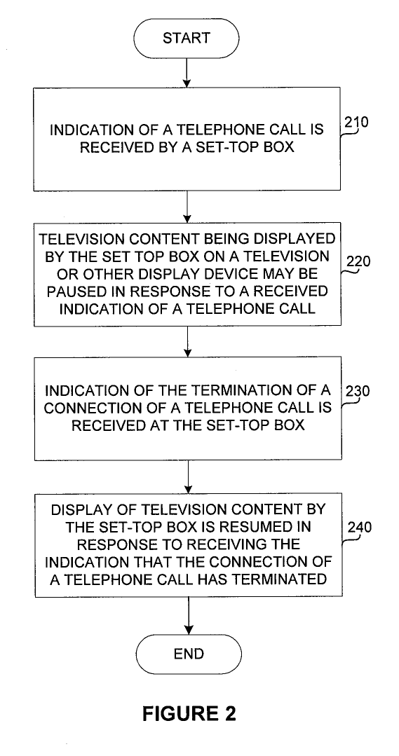

FIG. 2 illustrates one embodiment of a method for controlling a television. In step 210, an indication of a telephone call is received by a set-top box. In one embodiment, the indication may be generated in response to the detection of a ringing signal associated with a telephone that is further associated with the set-top box. In an alternative embodiment, the indication of the telephone call is generated in response to the telephone call being answered or a telephone call otherwise being connected between two parties. In one embodiment, the telephone call is directed to a telephone that is integrated with the set-top box. For example, the set-top box may act as a base station for a handset or headset that communicates with the set-top box using any suitable wireless protocol. In such an embodiment, the base station and traditional television set-top box functionality are integrated in a single device. Thus, such a set-top box would be equipped with a modem, dialer, SIP protocol stack, cellular transceiver, or any other suitable functionality enabling the set-top box to function as a telephone. In one embodiment, the set-top box may be connected to the Internet or any other suitable digital network. In such an embodiment, a remote Voice-Over-IP (“VoIP”) telephone may be pre-associated with such set-top box even though such VoIP telephone is located remotely from such set-top box. In one embodiment, the VoIP telephone may utilize the Internet or another digital network to communicate an indication that a telephone call has been initiated or connected between the VoIP telephone and a remote telephonic device. Step 210 is described relative to the receipt of an incoming ring signal and/or call connection relative to a telephone. In one embodiment, an outbound telephone call that is either dialed or connected may generate the indication of the telephone call such that outbound calls may also trigger the features of the present invention.

In step 220, television content that is being displayed by the set-top box on a television or other display device may be paused in response to a received indication of a telephone call. For example, a set-top box equipped with a digital video recorder (“DVR”) contains content previously stored on such DVR may pause the display of such recorded content in step 220. Alternatively, in a similar manner, a command may be generated by the set-top box to pause the display of additional video content or audio content provided by a device that is peripheral to the set-top box such as a DVR, Internet television receiver, or other digital or analog audiovisual device that serves as a source of recorded, broadcast, or streamed content being displayed or listened to by a user of the set-top box or other device. In one embodiment, pausing the display of television content may trigger a recording of live television content that was not previously being recorded. In such an embodiment, the display of such live television content would be paused and instead recorded by the set-top box or digital video recorder. When the set-top box is unable to record multiple streams concurrently, the system may display a message to the television indicative of such limitation when the live television content would normally be recorded if another recording is already in progress. In various embodiments, the pausing of programming or other content may occur each time a user picks up a phone, each time a dial tone is detected, each time a key is pressed or a send button is pressed, only for inbound calls, only for inbound calls received from particular individuals or telephone numbers, or only for outbound calls. In one embodiment, programming should only be paused or recorded if a particular type of programming is being played. In such an embodiment, logic that determines whether content should be paused or recorded accesses programming information such as a programming guide provided by a cable television company on a set-top box or via an online resource referenced by website and searched using location, service provider name, and the channel currently being viewed by a user. In such an embodiment, only movies may be paused. In another embodiment, only particular televisions are paused as indicated by a user.

In step 230, an indication of the termination of a connection of a telephone call is received at the set-top box. Such indication may be received, for example, in response to a party to a telephone call hanging up a telephone, a dropped call, or, in a particular embodiment, a call being placed on hold by a user of a telephone.

In step 240, the display of television content by the set-top box is resumed in response to receiving the indication that the connection of a telephone call has been terminated. For example, previously recorded content that was paused in response to a telephone call being connected or initiated may be resumed in response to the telephone call being terminated or the telephone call not being answered after a pre-determined length of time. In various embodiments, television programming may resume after three unanswered rings of a telephone, after a call is completed, after a call goes to multi-media messaging, after a resume or similar button is pressed on a telephone or a remote control, after any button is pressed on a remote control, or when an accelerometer or other indicator detects that a remote has been picked up by a user. In one embodiment, live television content that was triggered to be recorded based on an incoming call connection request or a call being connected may be played from the memory of the set-top box or another digital device. Thus, content that was previously paused while a telephone call was taken may resume and be displayed in the same manner in which it was being displayed before the telephone call was initiated.

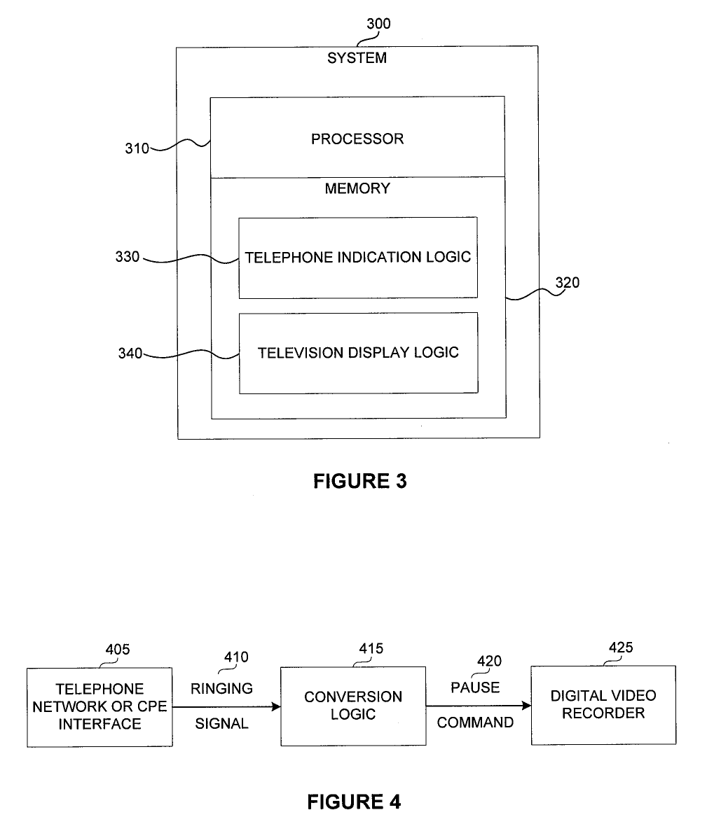

FIG. 3 illustrates a system 300 for controlling a television. The system 300 includes a processor 310 and a memory 320. In one embodiment, processor 310 is a microprocessor. However, processor 310 may be a central processing unit, microcontroller, ASIC, or any other suitable combination of hardware and software. In one embodiment, memory 320 is a read-only memory device. However, alternatively, memory 320 may include one or more memory components such as random access memory, read-only memory, flash memory, a dedicated hard-drive, or any other suitable combination of hardware and software structured and organized in any suitable manner for storing the instructions described in this FIG. 3. Although illustrated in FIG. 3 as separate components, processor 310 and memory 320 may be a single integrated component such as an ASIC.

Memory 320 includes telephone indication logic 330 and television display logic 340. Telephone indication logic 330 includes logic and instructions capable when executed by processor 310 of receiving or generating an indication of an incoming telephone call or an outgoing telephone call. Thus, telephone indication logic 330 may include logic operable to detect the occurrence of a call connection request being received by a remote network element such as a switch, the detection of a ringing signal generated by a telephone, the detection of a telephone call being answered by a recipient, the detection of a telephone call being terminated by a participant, or the detection of a telephone call being dialed by a user of a telephone. Call detection logic 330 may be implemented to receive and interpret an indication of a telephone call from a variety of different telephony networks and devices. For example, telephone indication logic may be configured to receive an indication of a call connection request from a digital network such as the Internet, from a cellular network such as a CDMA network, from local customer premises equipment such as an actual telephone over any suitable local network or connection, from a cable television network in communication with a telephone network, or directly from a PSTN telephone network. In such a manner, system 300 may interact with a variety of telephony devices, network, and technology. As a result, system 300 may be integrated with a variety of different interface types sufficient to support the receipt of call signaling and other telephone call information from a variety of different sources. Although not illustrated herein, system 300 may include separate interfaces for VoIP, cellular, and PSTN telephone networks. System 300 may include other wired and wireless interfaces, whether analog or digital in nature, potentially requiring additional system components such as analog to digital converters, noise removal, amplification, buffers, and any other suitable electronics.

In one embodiment, a variety of telephony technologies and call signaling events may be generated by a remote device such as a network device of a service provider providing television service to the user. In such an embodiment, a common format, protocol, or signaling scheme may be utilized for all types of telephony technologies when communicating call connection and termination information from such remote network device to the set-top box. In such an embodiment, the cost, number of components, in complexity of manufacturing the set-top box may be reduced.

Television display logic 340 may include instructions and logic operable when executed by processor 310 to pause the display of television content by the set-top box in response to a received indication of a telephone call. Television display logic 340 may also include instructions that are operable when executed by the processor to record television content in response to the received indication of a telephone call. Television display logic may further include instructions when executed by the processor that are operable when executed by the processor to resume the display of television content when a telephone call has been terminated. In one embodiment, television display logic includes logic operable to generate instructions to a digital video recorder. In yet another embodiment, such instructions are operable to generate instructions to a DVD player, VCR, stereo, MP3 player, or other analog or digital audio visual device that is a source of content for display or playback by the device, over a television or otherwise. Such instructions may be generated in a variety of formats. For example, such instructions may be generated over a circuit or interface that is integral to the set-top box itself. Alternatively, logic may be utilized to generate signaling for communication to peripheral components over interface cables, wirelessly, optically, or using any other suitable communications interface and medium.

FIG. 4 illustrates one embodiment of a system for ring monitoring. The system includes a telephone network or CPE interface 405 that communicates a ring signal 410 to conversion logic 415. The conversion logic 415 communicates a pause command 420 to a digital video recorder 420. The structure and functionality of interface 405 may differ depending on the type of telephone network or consumer premises equipment with which it is associated. For example, in one embodiment associated with a twisted pair connection utilized in a PSTN network or an analog telephone, an analog excitation signal may be sampled by interface 105. In such an embodiment, interface 405 may be a simple analog-to-digital-converter with associated peripheral circuitry combined with any suitable telephone ringer circuit, such as the ringer circuit disclosed in U.S. Pat. No. 4,042,786, the teachings of which are hereby incorporated by reference. The converter is in electrical contact with a ring generation circuit such that the same excitation signal that generates a ringing signal also generates a digital output from the analog-to-digital converter that is then communicated as ringing signal 410.

In another embodiment, interface 405 may be a wireless interface designed to receive a wireless ringing or paging signal from a base station in the same manner that a wireless headset or wireless ringer would function, such as the ring detection disclosed in U.S. Pat. No. 5,991,604, the teachings of which are hereby incorporated by reference. In such an embodiment, interface 405 includes one or more wireless receivers that may, for example, receive an indication of a ringing signal from a wireless base station.

In yet another embodiment, interface 405 may include a microphone and audio sampling circuit. In such an embodiment, a ringing signal of a telephone can be stored for later recognition by interface 405 for purposes of detecting when a telephone in a residence or other facility is ringing. Different ringing signals may be stored and reacted to differently. For example, the ringer or ring-tone for a particular individual may cause the display of a television show to be paused and recorded, while other ringing signals may be ignored or disregarded.

In yet another embodiment, interface 405 may be a VoIP interface. In such an embodiment, software or digital circuitry may be utilized to receive an Internet protocol packet, determine that such packet is indicative of an incoming VoIP telephone call connection request, and generate a ringing signal 410. In one embodiment, a VoIP CODEC may be easily utilized to generate a signal or trigger indicative of ringing signal 410. In another embodiment, a packet sniffer may be utilized to determine the presence of a call connection request in a particular IP packet. In a VoIP embodiment, a set-top box may function as both a broadcast endpoint for television services and an access point or base station for voice services, such as the system disclosed in U.S. Patent Publication No. 2006/0072622 A1, the teachings of which are hereby incorporated by reference.

Ringing signal 410 may be any analog or digital signal, level, trigger, or other data communicated to conversion logic 415 that is indicative of a ringing telephone or other indication of an incoming connection request. Ringing signal 410 may be communicated over any wired or wireless connection, including, without limitation, via a Bluetooth, Wifi, fiber optic, USB, or other suitable connection.

Conversion logic 415 may be an ASIC, software, digital circuitry, or other suitable logic that receives ringing signal 410 and converts it into a pause command 420 to pause the playing and/or initiate the recording of viewed or listened to content. For example, conversion logic may convert a detected ring into a pause command 420 to pause a DVR or DVD player. Conversion logic 415 may also generate a pause command 420 to begin recording on a DVR or DVD player. Pause command may be communicated over any wired or wireless connection, including, without limitation, via an infrared, Bluetooth, Wifi, fiber optic, USB, or other suitable connection. Although the term conversion is used with respect to conversion logic 415, conversion includes mere detection of a ringing signal 410 and the subsequent generation of pause command 420.

In one embodiment, interface 405 and conversion logic 415 may be integrated as a single device that may be sold as an accessory to a telephone or set-top box. In such an embodiment, the interface 405 may be an interface to a telephone or base station that monitors a ringing signal generated by such telephone or base station. In such an embodiment, conversion logic 415 may generate pause command 420 as an infrared or other wireless signal to a set-top box or digital video recorder as if such device were functioning as a remote control. In such an embodiment, such device could be programmable using the same methodology as a universal remote, which is well known in the art. Similarly, such device could be programmable to operate with a base station for a wireless handset or headset as if such device were a handset or headset. Instead of generating a ringing signal, such device would instead generate a pause command for a set-top box or digital video recorder. Such device may be connected to the telephone or base station using any suitable wired or wireless interface.

In another embodiment, a telephone may be sold that includes inherent functionality of interface 405 and conversion logic 415. For example, a wireless handset may include logic, such as programming or electronics, to generate a pause command using, for example, built-in universal remote functionality, in response to receiving an indication of an incoming call.

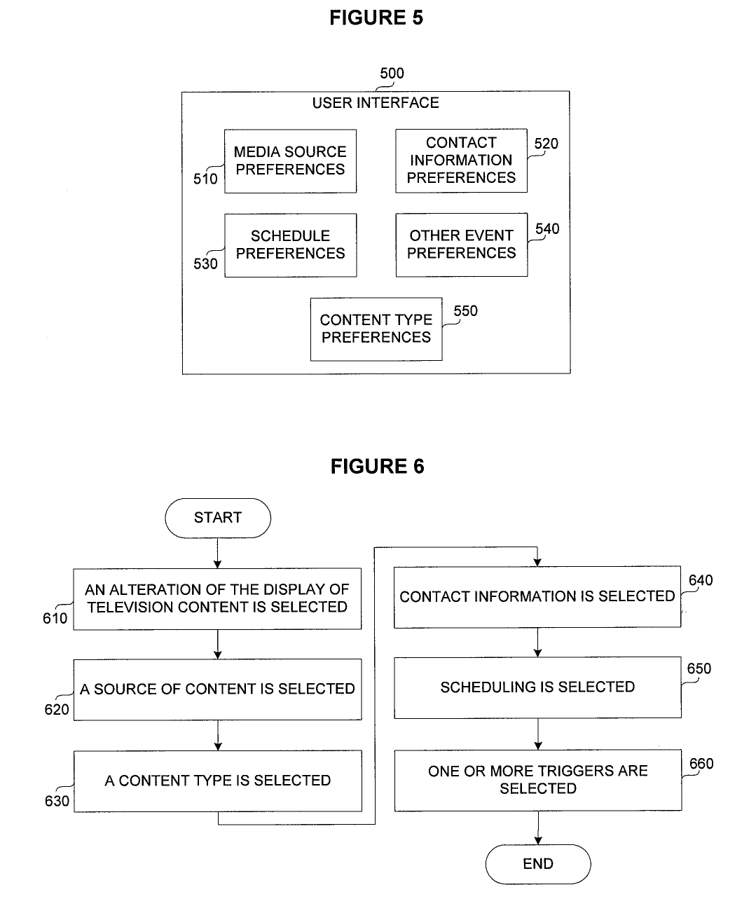

FIG. 5 illustrates one embodiment of a user interface 500 for implementing particular features of the present invention. In one embodiment, user interface 500 is a web-based graphical user interface accessible on a portal of a service provider providing voice and/or television services to a consumer. Alternatively, however, user interface 500 may be part of client software hosted on a computer of the consumer, a voice-interactive menu available by dialing a telephone number, a screen and menu displayed on a television by a set-top box, or any other suitable configuration. In yet another embodiment, user interface 500 may be integrated within a network address book. A network address book may be a list of contacts and contact information associated with a particular user of telecommunication services that is stored on a server or that is otherwise available to the user of a network for viewing, modification, and usage.

While the exact organization, structure, and sequence of selections is not important, user interface 500 includes preferences associated with one or more sources of media content for pausing, pausing and recording, or resuming (all of which are considered to be nonexclusive subsets of the term “altering” for purposes of this application) the display, listening, streaming, broadcast, or playback (collectively the “display”) of media from such sources. Such preferences may further indicate events (also referred to as triggers) associated with a telephone, telephone call, or other telecommunications communication that may be selected to alter the playing of media from a source of media. Such preferences may be further associated with information in an address book, calendar, contact list, to do list, or other source of information regarding the contacts and schedule of a user. For example, a user may indicate that the playing of media content is to be paused when a call is received at the time that a meeting or conference call is scheduled on a calendar, in any event or only in the event of the call being identified as being from a participant in such meeting or conference call. Preferences may also be associated with other events, such as a doorbell being pressed or a room entry being detected. Preferences may also be associated with the particular content being displayed. For example, content categorized as a movie or a sporting event may have a different indicated preference than content categorized as local news or children's programming.

For purposes of illustration, user interface 500 is illustrated as including media source preferences 510, contact information preferences 520, schedule preferences 530, other event preferences 540, and content type preferences 550. Media source preferences 510 may be any preference associated with a particular device or portion of a device, such as, for example, set-top box 1, set-top box living room, DVR, DVD player 1, internet television receiver 2, radio content, CD player content, XMR radio content, any device that a particular user is watching or listening to, or any other identifiable source of media content. Contact information preferences 520 may be associated with a particular address book, a particular contact, a particular type of contact, a particular telephone number, IP address, or email address, or any other information regarding a contact of a user. Schedule preferences 530 may be associated with a calendar, a calendar entry, a time of day, a day of the week, a day of the year, an out of office reminder, a scheduled meeting, a scheduled telephone call, or any other information regarding the schedule of a user. Other event preferences 540 may be associated with a doorbell, detected entry, alarm indication, timer expiration, alarm clock, household appliance, or other device or event. Content type preferences 550 may be associated with a category of media content such as a movie, sporting event, children's programming, particular television channel, particular television show, media type such as video or music, a particular artist, actor, or director, or any other suitable categorization, characteristic, or identification. Content type preferences may reference information obtained or obtainable from a set-top box or other programming guide on the Internet or otherwise.

FIG. 6 illustrates one embodiment of a method of selecting preferences for controlling television content. In step 610, an alteration of the display of television content is selected. For example, “pause” may be selected. In step 620, a source of content is selected. For example, “living room set-top box” may be selected. In step 630, a content type is selected. For example, “all content” or “movies” may be selected. In step 640, contact information is selected. For example, “my network address book” may be selected, followed by a further selection of “work contacts.” In step 650, scheduling is selected. For example, “prime time” may be selected to indicate the time of 7 p.m. to 10 p.m. In step 660, one or more triggers are selected. For example, “VoIP telephone line 1” may be selected, followed by a further selection of “inbound call” or “any telephone movement.” Alternatively or additionally, “doorbell” may be selected.

The previous detailed description is of a small number of embodiments for implementing the invention and is not intended to be limiting in scope. The following claims set forth a number of the embodiments of the invention disclosed with greater particularity.

What is claimed:

1. A method of controlling a television, the method comprising:
receiving an indication of a telephone call at a set-top box; and
pausing the display of television content by the set-top box in response to the received indication.

2. The method of claim 1, wherein the method further comprises resuming the display of television content when a telephone call is terminated.

3. The method of claim 1, wherein pausing the display of television content further comprises recording the display of television content.

4. The method of claim 1, wherein pausing the display of television content comprises pausing a digital video recorder.

5. The method of claim 1, wherein the indication of the telephone call is an indication of an incoming telephone call.

6. The method of claim 1, wherein the method further comprises generating the indication at a telephone handset.

7. The method of claim 1, wherein the method further comprises generating the indication at a network device located remotely from the premises where the set-top box is located.

8. A set-top box, the set-top box comprising:
a telephone interface, the telephone interface operable to receive an indication of a telephone call; and
a digital video recorder, the digital video recorder operable to pause the display of television content by the set-top box in response to the received indication.

9. The set-top box of claim 8, and further comprising a telephone base station, the telephone base station in communication with the telephone interface, the telephone base station operable to generate the indication of an incoming telephone call when a ringing signal is communicated to a telephone from the telephone base station.

10. The set-top box of claim 8, and further comprising a telephone base station, the telephone base station in communication with the telephone interface, the telephone base station operable to generate the indication of the telephone call when a telephone in communication with the telephone base station answers a telephone call.

11. The set-top box of claim 8, wherein the telephone interface includes a network interface, wherein the network interface is operable to receive the indication of the telephone call from a network device located remotely from the premises where the set-top box is located.

12. The set-top box of claim 8, wherein the telephone interface includes an off-hook detector associated with one or more telephones, the off-hook detector operable to generate the indication of the telephone call.

13. The set-top box of claim 8, wherein the telephone interface includes an IP interface, wherein the IP interface is operable to receive the indication of the telephone call from the Internet.

14. The set-top box of claim 8, wherein the set-top box includes a SIP protocol stack, wherein the SIP protocol stack is operable to generate the indication of the telephone call.

15. A system for controlling a television, the system comprising:
a processor; and
a memory in communication with the processor, the memory being encoded with instructions, the instructions operable when executed by the processor to:
receive an indication of a telephone call at a set-top box; and
pause the display of television content by the set-top box in response to the received indication.

16. The system of claim 15, wherein the instructions are further operable when executed by the processor to resume the display of television content when the telephone call is terminated.

17. The system of claim 15, wherein the instructions are further operable when executed by the processor to pause the display of television content further comprises recording the display of television content.

18. The system of claim 15, wherein the instructions are further operable when executed by the processor to pause the display of television content comprises pausing a digital video recorder.

19. The system of claim 15, wherein the instructions are further operable when executed by the processor to pause the display of television content comprises pausing a DVD player.

20. The system of claim 15, and further comprising a telephone base station in communication with the processor, the telephone base station operable to generate the indication the incoming telephone call.
